(19) United States
(12) Patent Application Publication
(10) Pub. No.: US 2014/0146719 A1
(43) Pub. Date: May 29, 2014

(54) METHODS, APPARATUSES AND COMPUTER PROGRAM PRODUCTS FOR INTERFERENCE MITIGATION VIA CHANNEL RESERVATION IN LA TDD NETWORK

(71) Applicants: Chunyan Gao, Beijing (CN); Erlin Zeng, Beijing (CN); Haiming Wang, Beijing (CN); Jing Han, Beijing (CN); Tommi Koivisto, Espoo (FI)

(72) Inventors: Chunyan Gao, Beijing (CN); Erlin Zeng, Beijing (CN); Haiming Wang, Beijing (CN); Jing Han, Beijing (CN); Tommi Koivisto, Espoo (FI)

(73) Assignee: Broadcom Corporation, Irvine, CA (US)

(21) Appl. No.: 14/131,346

(22) PCT Filed: Jul. 8, 2011
(86) PCT No.: PCT/CN2011/077003

§ 371 Date: Jan. 7, 2014

(51) Int. Cl. H04J 3/16

(52) U.S. Cl. CPC H04J 3/1694
USPC 370/278

(57) ABSTRACT

Apparatuses, methods and computer program products are proposed, by which resource elements in an uplink transmission of a user equipment are determined, on which interference may be caused and which are to be muted in the uplink transmission, and wherein the user equipment is configured to mute resource elements based on the determined resource elements.

### FIELD OF THE INVENTION

The present invention relates to methods, apparatuses and computer program products interference mitigation via channel reservation in a time division duplex network environment, for example a LA (local area) TDD network.

### BACKGROUND

Mobile data transmission and data services are constantly making progress. With the increasing penetration of such services, a need for increased bandwidth for conveying the data is emerging. The more efficiently bandwidth is used, the higher the probability for interference gets. In particular, inference on control data or control channels is crucial as corrupted control data will adversely affect the entire system performance and operation.

Currently, a system known as Long Term Evolution LTE is being further developed. The present invention relates to its further development referred to as LTE-Advanced system (LTE-A), which will be part of 3GPP LTE Rel-11. More specifically, it focuses on the configuration of a TDD system in a local area scenario.

Allowing for asymmetric UL-DL allocations has been claimed as one benefit of deploying TDD system. The asymmetric resource allocation in LTE TDD is realized by providing seven different semi-statically configured uplink-downlink configurations. These allocations can provide (in uplink direction) between 40% and 90% of the DL subframes.

For TDD deployments in general, interference between UL and DL including both basestation-to-basestation and UE-to-UE interference needs to be considered. The DL-UL interference in a TDD network is typically handled by statically provisioning a guard period and adopting the same frame timing and uplink-downlink configuration practically in the entire network. However, in local area (LA) network, it may be of interest to consider different UL/DL allocations in the neighbouring cells, since same DL/UL configuration may not match the traffic situation in different LA cells with a small number of users.

The main property as we consider for a LA network scenario is that the typical cell size is small comparing with a macro cell, and the number of UEs connected to each eNB (or AP) in the network is not large. And also, LA network deployment is maybe done in an uncoordinated manner, so that network planning and optimization are not considered. DL-UL interference is one obstacle to deploy flexible TDD LA network. Now consider a TDD deployment scenario with each cell frame synchronized, but not switch point synchronized. In this case, if each cell choose one TDD configuration from seven TDD configuration patterns defined, there is no DL-UL interference problem for subframe 0, 1, 2 and 5 since these subframes have fixed link direction in any TDD configurations defined.

For other subframes, their link direction can change with TDD configuration, and there can be DL-UL interference depending on the TDD configuration adopted in neighboring cells. Then in this IR, the subframes like 0, 1, 2 and 5 which have fixed link direction are called fixed subframe, while other subframes are called flexible subframe for simplicity. It is to be noted that the fixed subframe and flexible subframe can change depending on the TDD configurations allowed to be adopted, e.g., if a network only support TDD configuration 1 and 2, then subframe 0, 1, 2, 4, 5, 6, 7, 9 are all fixed subframe, while subframe 3 and 8 are flexible subframes which are set as UL in TDD configuration 1 and DL in TDD configuration 2.

DL-UL interference in flexible subframes will degrade the SINR significantly. For data transmission in flexible subframe, link adaptation and HARQ can help to adapt to the interference level, but for control signaling to be transmitted in the flexible subframe, it is more sensitive to the interference due to lack of HARQ, and it will further reduce the throughput (TP).

Two straightforward ways for DL-UL interference mitigation are as follows, but some disadvantages are identified for such methods:

A. Configuring all flexible DL subframes as blank subframe for the cell-edge UEs who are victims/generators of UL to DL interference.

This way, however, is too restrictive, since the UEs may still need to detect PHICH and UL grant in the flexible DL subframes. Though one can put limitations to allow control signaling only in the fixed subframes, some obvious disadvantages are identified as follows:
Increased DL control overhead in the fixed DL subframes
By putting all control in fixed subframe, new HARQ timing need to be introduced which will increase the implementation complexity;
The interference to/from the data channel in the flexible subframes remains unsolved.

B. Do not schedule UL transmission in flexible UL subframes for cell-edge UEs which would interfere, or be interfered by, the neighbor cells' DL transmission.

However, muting all the flexible UL subframes is too restrictive and not necessary since not all UL transmission there will harm DL transmission in neighboring cells; and one UL transmission will not harm all DL transmission in whole band in neighboring cells.

Moreover, since in case of carrier aggregation, the transmission in one carrier can be cross-scheduled by another carrier, so, the DL-UL interference from/to PDCCH does not exist in some cases. Besides PDCCH, CRS may also need to be protected to enable accurate channel estimation in some case, but not needed in other cases, e.g, when UE will demodulate based on DRS, or there is no cell edge UEs in neighboring cells. So, the channel/signal which need protection from DL-UL interference may be different in different cells. In such a case, only protect the most important channel will be more resource efficient.

Thus, there is still a need to further improve such systems in terms of proper interference reduction.

### SUMMARY

The present invention addresses such situation and proposes in exemplary embodiments, new solutions to efficiently reduce/mitigate UL-DL interference.

Various aspects of examples of the invention are set out in the claims.

According to a first aspect of the present invention, there is provided an apparatus, which comprises
a transceiver module configured for time division duplex operation in a network environment,
a processor module configured
to determine resource elements in an uplink transmission of a user equipment on which interference may be caused and which are to be muted in the uplink transmission, and to prepare configuration information for the user equipment in which resource elements to be muted are indicated,
wherein the transceiver module is configured to send the configuration information to the user equipment.

According to a second aspect of the present invention, there is provided an apparatus, which comprises
a transceiver module configured for time division duplex operation in a network environment and to receive configuration information indicating resource elements to be muted in an uplink transmission of the apparatus, and
a processor module, configured to mute resource elements based on the received configuration information.

According to a third aspect of the present invention, there is provided a method which comprises
in a transceiving configuration for time division duplex operation in a network environment,
determining resource elements in an uplink transmission of a user equipment on which interference may be caused and which are to be muted in the uplink transmission,
preparing configuration information for the user equipment in which resource elements to be muted are indicated, and
sending the configuration information to the user equipment.

According to a fourth aspect of the present invention, there is provided a method which comprises
in a transceiving configuration for time division duplex operation in a network environment, receiving configuration information indicating resource elements to be muted in an uplink transmission of a user equipment, and
muting resource elements based on the received configuration information.

In addition, according to further aspects of the present invention, there are provided computer program products comprising computer-executable components which, when executed on a computer, are configured to execute the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

Hence, aspects of the present invention provide apparatuses, methods and computer program products, by which resource elements in an uplink transmission of a user equipment are determined, on which interference may be caused and which are to be muted in the uplink transmission, and wherein the user equipment is configured to mute resource elements based on the determined resource elements.

Thus, according to embodiments of the present invention, new solutions to efficiently reduce/mitigate UL-DL interference are provided. Moreover, according to some embodiments, the solution can also be applied to reduce/mitigate interference in other deployment scenarios, e.g, HetNet or UL-UL interference in LA scenarios.

Advantageous developments are defined in the dependent claims.

### BRIEF DESCRIPTION OF DRAWINGS

For a more complete understanding of example embodiments of the present invention, reference is now made to the following descriptions taken in connection with the accompanying drawings in which:

FIG. 1 schematically illustrates apparatuses according to embodiments of the present invention, wherein as examples, FIG. 1A shows an eNB and FIG. 1B shows a UE,

FIG. 2 shows a message sequence according to an embodiment of the invention,

FIG. 3 shows an example of LA-TDD deployment,

FIG. 4 shows an example of muting REs in UL transmission according to an embodiment of the present invention,

FIG. 5 shows and example of data processing in UL transmission with muting REs according to an embodiment of the present invention, and

FIG. 6 shows an example of muting REs of the present invention.

### DESCRIPTION OF EXEMPLARY EMBODIMENTS

Exemplary aspects of the invention will be described herein below.

It is to be noted that the following exemplary description refers to an environment of the LTE system (long term evolution) and/or local area networks thereof. However, it is to be understood that this serves for explanatory purposes only. Other systems differing from the LTE system can be adopted as long as they deploy similar configurations and enable asymmetric resource allocation for uplink and downlink transmission to/from an access point such as an evolved Node_B eNB. Generally, aspects of the present invention can be deployed in relation to any TDD system (time division duplex) allowing for flexible allocation of transmission frames in terms of the link direction, i.e. uplink UL or downlink DL.

A respective eNB as an access point in the broadest sense communicates with one or more terminal apparatuses or devices referred to also as user equipment UE using control channels as well as payload channels. A user equipment can be a mobile phone, a smart phone or personal computer connectable to a network such as LTE network or other (WCDMA, WIMAX, WLAN or the like) as long as they deploy TDD.

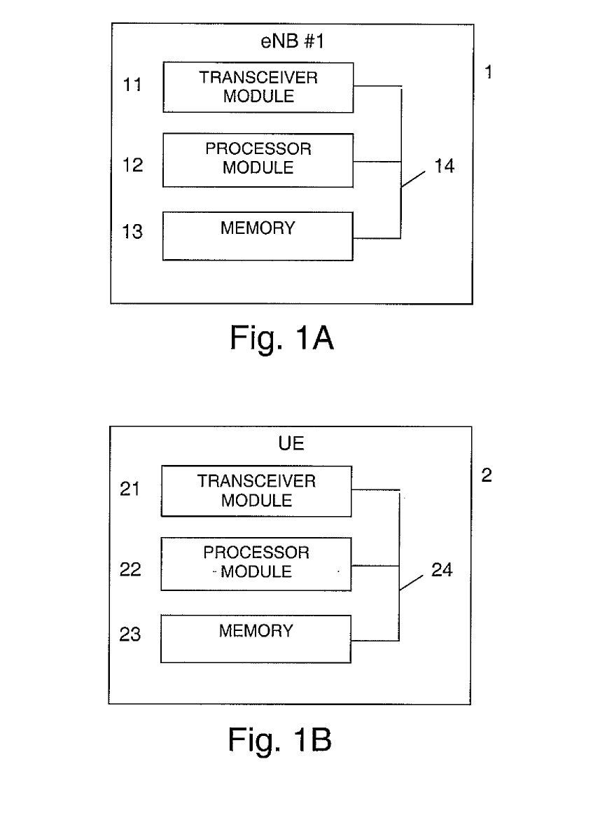

FIG. 1 illustrates a simplified block diagram of an eNB (termed as eNB #1) 1 according to an embodiment of the present invention. It is noted that the eNB, and the corresponding apparatus according to the embodiment may consist only of parts of the eNB, so that the apparatus may be installed in an eNB, for example. Moreover, also the eNB is only an example and may be replaced by another suitable network node, for example an access node such as a base station or the like.

The eNB 1 comprises a transceiver module 11 configured to configured for TDD operation in a network environment, and a processor module 12 configured to determine resource elements in an uplink transmission of a user equipment on which interference may be caused and which are to be muted in the uplink transmission, and to prepare configuration information for the user equipment in which resource elements to be muted are indicated. The transceiver module 11 is configured to send configuration information to the user equipment. The eNB 1 may also comprise a memory 13 in which programs for carrying out the functions according to the embodiment are stored. The transceiver module 11, the processor module 12 and the memory 13 may be inter-connected by a suitable connection 14, e.g., a bus or the like.

FIG. 1B illustrates a simplified block diagram of a user equipment 2 according to an embodiment of the present invention. It is noted that the user equipment is only an example, and the corresponding apparatus according to the embodiment may consist only of parts of the user equipment, so that the apparatus may be installed in a user equipment, for example.

The user equipment 2 comprises a transceiver module 21 configured for time division duplex operation in a network environment and to receive configuration information indicating resource elements to be muted in an uplink transmission of the apparatus. Furthermore, the user equipment comprises a processor module 22 which is configured to mute resource elements based on the received configuration information. The configuration information may be received from an network control element, e.g., an access node, such as the eNB 1 described above. The user equipment 2 may also comprise a memory 23 in which programs for carrying out the functions according to the embodiment are stored. The transceiver module 21, the processor module 22 and the memory 23 may be inter-connected by a suitable connection 24, e.g., a bus or the like.

Hence, according to embodiments of the present invention, only certain resource elements are muted in an uplink transmission of a user equipment. The resource elements to be muted are determined by an access node such as an eNB, for example. This is described in the following in more detail.

In particular, according to the present embodiment, an efficient interference mitigation, e.g., UL-DL interference mitigation in LA TDD system, is provided.

In order to enable efficient interference mitigation, e.g., UL-DL interference mitigation in LA TDD system, according to more detailed embodiments, the following solutions are proposed:

The UE can be configured to mute some REs in UL transmission in certain UL subframes, e.g., flexible UL subframes, in a serving cell denoted as cell #1 (which may be controlled by eNB #1 1 shown in FIG. 1A);

The muting REs may determined by the cell #1 (e.g., eNB 1 shown in FIG. 1A) based on information obtained from a neighboring cell #2, for example:
Which signals/channels are reserved/need to be protected, e.g., CRS/PDCCH/PCFICH/PHICH;
Configuration of the reserved signals/channels (channels to be protected), e.g, antenna ports for CRS, number of symbols for PDCCH, PHICH duration;
Physical layer cell ID of cell #2;
Interference level detected;
TDD configuration in cell #2.

In case there are multiple neighboring cells #2 reporting the reserved channels/signals, the cell #1 can choose the muting REs based on one cell's information, e.g., the cell #2 with the strongest interference level.
The cell #1 signals the muting REs to relevant UEs.
The signaling can convey information on the reserved channel/signals, based on which UE is able to derive the RE set S that need to be muted in UL transmissions.

Besides the explicit signaling from cell #1 eNB, there can be additional rules predefined to help cell #1 UE to determine the muting RE set S, e.g,
The number of residual subcarriers, M, after muting in each symbol should satisfy M=2ⁱ·3^{j}·5^{k} to enable low complexity DFT operation. The parameters i, j and k are arbitrary integers. When the number of REs to be muted complies with this condition, the operation load for a further such as of a DFT can be reduced. It is noted that this condition is only one example for a condition that the number of REs to be muted fulfills a specific condition.
For a UE configured muting REs, the UE forms the UL transmissions so that the REs corresponding to the RE set S are not used for UL transmissions, or used for UL transmissions with zero power.

That is, in the present embodiments, the term “muting” means that the RE to be muted is not transmitted, or is transmitted with zero power.

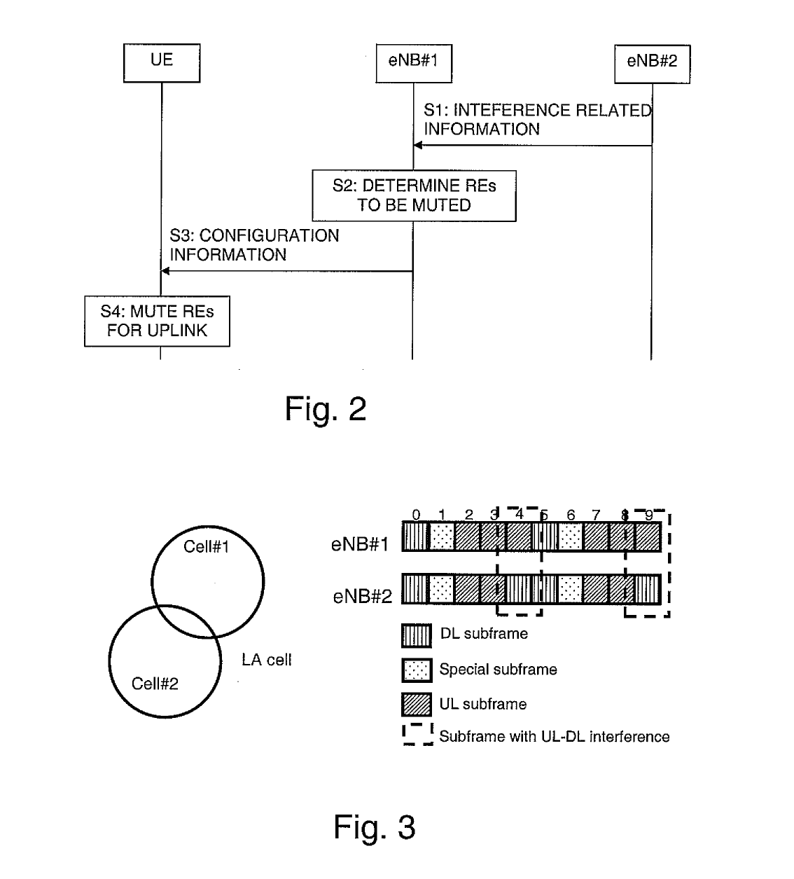

FIG. 2 shows a signaling diagram according to an embodiment of the present invention.

In step S1, the eNB #2 sends interference related information to the eNB #1, since the eNB #2 has detected that a certain UE in cell #1 (served by eNB #1) may cause UL-DL interference, for example. In step S2, the eNB #1 determines, based on the received information, which REs should be muted by the UE. It is noted that the eNB #1 may also detect itself probable UL-DL interference. That is, the eNB #1 may carry out step S2 also without the information of eNB #2.

In step S3, the eNB #1 sends configuration information, which include information about the REs to be muted, to the UE. In step S3, the UE mutes REs in uplink. It is noted that the REs actually muted may not completely identical to those as indicated in the configuration information; for example the UE may mute more REs than indicated in order to simplify further processing (e.g., DFT processing or the like), or other REs in order to protect subframes containing certain channels, as will be explained in the following in more detail.

Compared with PRB level, OFDM symbol-level, of subframe-level interference coordination, the RE-level muting based on indicated reserved channel/signals has higher spectrum efficiency.

It is noted that the solution is not limited to the UL-DL interference mitigation in LA-TDD scenarios, it can be applied to other scenarios for interference avoidance, e.g, macro-LA interference, LA-LA UL-UL interference.

In the following, an embodiment is described, in which a concrete example of flexible subframes and interference in the flexible subframes is described.

FIG. 3 shows one example of different TDD configuration in neighboring cells, where due to different TDD configuration, there can be UL-DL interference in subframe 4.

According to the present embodiment, the cell #2 (served by eNB #2) which has DL transmission which may face interference from cell #1 can send information to cell #1 on the reserved channel/signals, which is the channel/signals need to be protected. The channels can be, but not limited to one or combination of the followings:
PDCCH
PHICH
PCFICH
CRS

In case there is no cell-edge UEs in cell #2, then UL-DL interference is not a problem for the serving UEs, and cell #2 will not indicate the reserved channels/signals to cell #1. Note that the eNB #2 can use for example RSRP reports to determine which UEs would cause UL-DL interference.

In case, there is one or more cell-edge UEs in cell #2, but cell #2 will not schedule cell-edge UEs in the flexible subframe 4, cell #2 may only indicate PCFICH/PHICH as reserved channels/signals to cell #1.

In case, there is cell-edge UEs in cell #2, but they are not required to detect PDCCH there due to cross-CC scheduling by another carrier, the cell #2 may not indicate PDCCH/PCFICH/PHICH as reserved channel to cell #1, instead, it may indicate CRS as reserved signal if cell-edge UEs will detect based on CRS.

The information related to reserved channels/signals can be sent to cell #1 via backhaul, ×2, or other reserved channel, for example.

For the cell #1 (served by eNB #1), when detected the signaling on reserved channel/signals, it may or may not have reaction depending on whether there is cell edge UEs in cell #1. If there are UEs close to the cell #2 which reported reserved channels/signals, cell #1 will configure the UE to mute some REs derived from the reserved channels/signals. If there are multiple neighboring cell #2 reported the reserved channels/signals, the cell #1 can choose muting REs to avoid interference to some of the selected channels/signals from one or multiple cells and inform the relevant UEs. The signaling to the UE can be reserved channel and corresponding information to help UE deriving the muting REs' pattern. The configured muting REs is UE-specific.

In the following, the resource elements selected by cell #1 to be muted are referred to as a RE set S.

Next, the detailed way of muting a RE set S in UE's UL transmissions according to the embodiment is described, where the set S would be determined based on the above proposal.

For a UE configured muting REs, the UE divides the complex valued data symbols into multiple sets based on available number of SC-OFDM symbols for data transmission. There are different number of data symbols in each set due to muting REs. Assume that K PRBs are allocated for UL transmission, and let's assume for a given SC-OFDM symbol, UE needs to mute L REs among all the REs according to the set S.

Then, for SC-OFDM symbol with L muting REs, the data set consists of M₁=12×K−L complex valued symbols, and M₁-points DFT is used before mapping to M₁ unmuted REs in the allocated frequency resource.

The L muting REs is derived based on signaling from eNB (i.e., eNB #1) on reserved channel/signals; but more rules can be put to the L REs to reduce impact to UL performance or reduce implementation complexity. For example, the rules can be:

I. Muting REs should avoid the UCI to be transmitted in PUSCH.

II. Muting REs should be avoided in PUCCH.

III. The number of residual REs after muting in each symbols should satisfy M₁=12×K−L=2¹·*3^{j}·5^{k}.

For SC-OFDM symbol without muting REs, the data set consist of M₂=12×K complex valued symbols, and M₂-points DFT is used before mapping to the allocated frequency resource.

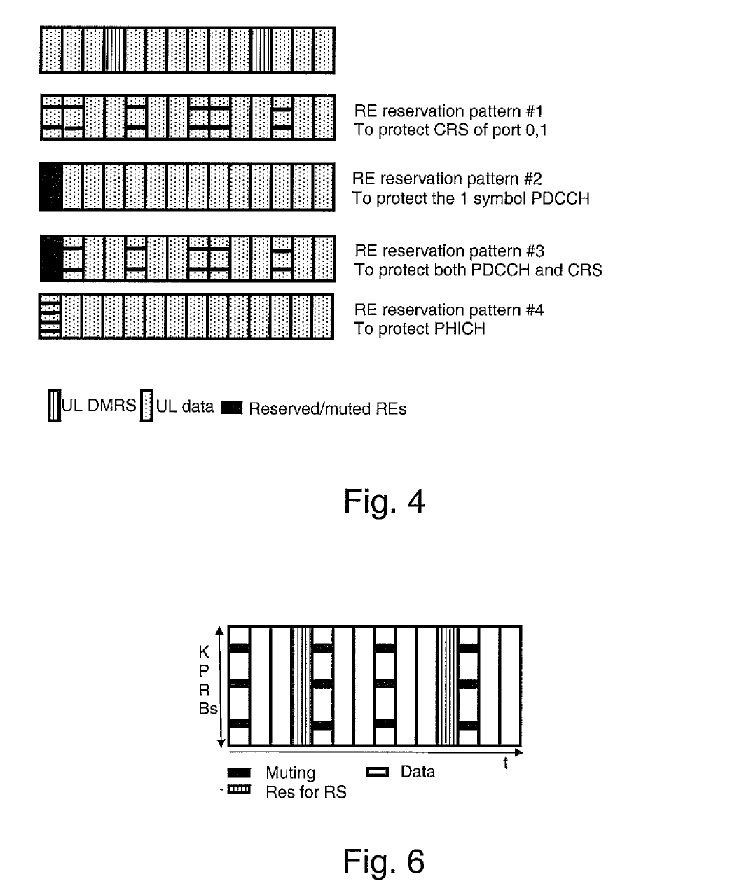

In FIG. 4, there are some examples of the muting REs in UL transmission according to the reserved channel/signals.

That is, in an RE reservation pattern #1, the REs to be muted are selected such that CRS of port 0, 1 is protected.

In an RE reservation pattern #2, the REs to be muted are selected such that the 1 symbol PDCCH is protected.

In an RE reservation pattern #3, the REs to be muted are selected such that both PDCCH and CRS are protected.

In an RE reservation pattern #4, the REs to be muted are selected such that PHICH is protected.

It is to be noted that besides the information on reserved channel/signals, additional rules as shown above in I-III can be applied to help determining the muting RE set S. For example, according to the rule I, though some REs need to be muted based on the indication of reserved channel/signals, they will still be used for UL transmission to get better performance of UCI.

According to rule III, more REs than required by the reserved channel/signals can be muted to satisfy the requirement of M₁=2ⁱ·3^{j}·5^{k} to enable low complexity DFT operation. In this case, the additionally muted REs is to be predefined to achieve common understanding between UE and eNB, e.g., the additional REs should be the first X REs among those left by reserved channel/signals in the allocated resource, and X=(12×K−L′)×M₁, where K is the allocated number of PRBs, L′ is the required number of muted REs by reserved channel/signals and M₁ is the number of residual REs satisfying the rule III.

At the UE side, after getting the L muting REs where to avoid transmission, it will divide the complex-valued data symbols into sets, e.g., into 12 sets in case 12 SC-FDMA symbols available. What to be noted is that there are different number of data symbols in each set in case muting REs are configured, as shown in FIG. 3. This structure guarantees that what generated is still SC-FDMA symbols.

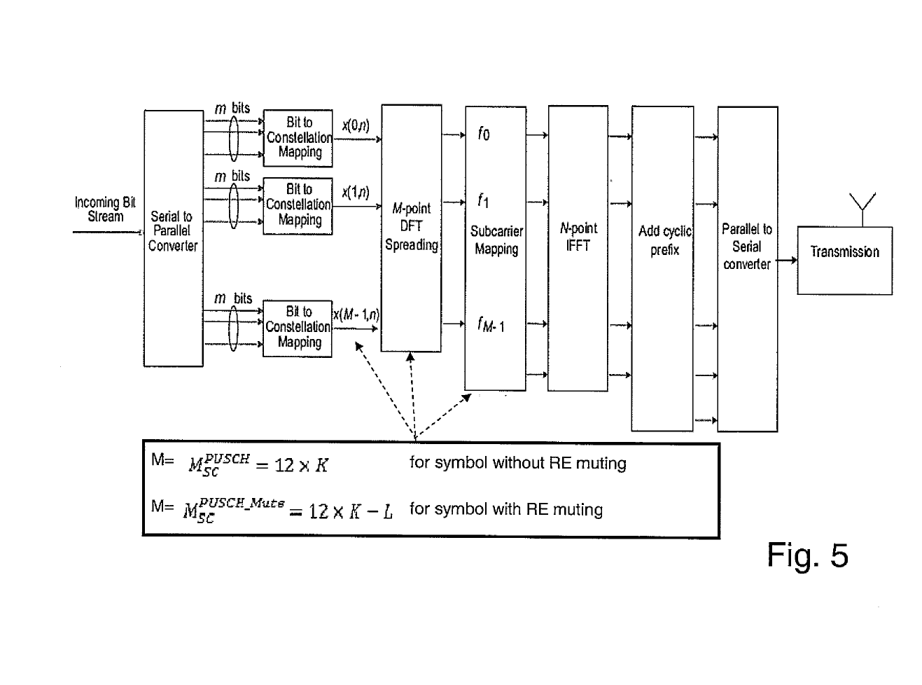

FIG. 5 shows an example of data processing in UL transmission with muting REs. The illustrated elements be functional elements of the processor module 22 shown in FIG. 1B, for example, except for the transmission function which may provided by the transceiver module 21 shown in FIG. 1B.

In this example, it is assumed that K PRBs are allocated for UL transmission, and that there are L REs muted in some SC-FDMA symbols as illustrated in FIG. 6.

Considering that the fact that the number of REs for PHICH and PCFICH in an interfered cell can be 12 (use number is small in LA) and 16, and PDCCH CCEs in a LA cell can be limited to predefined resources and the total number is not large in LA (e.g., 3 UEs with two CCEs which means around 200 REs), only muting the REs derived based on the reserved channels of PCFICH/PHICH/PDCCH will provide higher spectrum efficiency than both PRB or subframe level muting.

It should be noted that here UL-DL interference mitigation is just one use case of the interference mitigation method, and besides this, the solution can also be used for RE-level interference mitigation based on reserved channel/signals in other scenarios.

The invention is not limited to the embodiments as described above. For example, in the embodiment described in connection with FIG. 5, it was described that the UE selects the REs to be muted based also on certain rules (rules I to III). However, also the eNB may apply these rules when selecting the REs to be muted and to be indicated to the UE. In this way, the operation load on the UE could be reduced.

Moreover, the rules I to III mentioned above are merely examples for conditions, based on which the REs actually muted are selected. That is, the REs to be muted may be selected not only based on the REs of which it is determined that there might be interference thereon, but in addition also based on specific conditions.

Thus, according to embodiments of the present invention, an advantage is achieved that that the spectrum efficiency is improved by only muting the necessary REs while at the same time providing the required UL-DL interference avoidance.

Hence, according to embodiments of the invention, UL-DL interference can efficiently reduced/mitigated. Moreover, the proposed solution can also be applied to reduce/mitigate interference in other deployment scenarios, e.g., HetNet (heterogeneous networks) or UL-UL interference in LA scenarios.

Embodiments of the present invention may be implemented in software, hardware, application logic or a combination of software, hardware and application logic. The software, application logic and/or hardware generally, but not exclusively, may reside on the apparatus' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or apparatus, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected apparatuses, and/or modems or other modules thereof.

If desired, at least some of different functions discussed herein may be performed in a different order and/or concurrently with each other. Furthermore, if desired, one or more of the above-described functions may be optional or may be combined.

According to further embodiments of the present invention, an apparatus is provided, comprising
means for, in a transceiving configuration for time division duplex operation in a network environment, determining resource elements in an uplink transmission of a user equipment on which interference may be caused and which are to be muted in the uplink transmission,
means for preparing configuration information for the user equipment in which resource elements to be muted are indicated, and
means for sending the configuration information to the user equipment.

According to further embodiments of the present invention, an apparatus is provided which comprises
means for, in a transceiving configuration for time division duplex operation in a network environment, receiving configuration information indicating resource elements to be muted in an uplink transmission, and
muting resource elements based on the received configuration information.

The various aspects and embodiments can be modified as follows:

Information may be obtained from a neighboring cell, and the determination of the resource elements to be muted may be performed based on the obtained information.

The obtained information may comprises at least one of the following:
information as to which signals and/or channels are reserved and/or need to be protected,
configuration of the reserved signals and/or channels to be protected,
physical layer cell identity of the neighboring cell,
interference level detected, and/or
time division duplex configuration of the neighboring cell.

In case information is obtained from more than one neighboring cell, the resource elements to be muted may be selected based on information of one neighboring cell. For example, the one neighboring cell may be selected based on information regarding the strongest interference level.

Moreover, resource elements to be muted may be selected based on the resource elements determined as resource elements on which interference may be caused and based on at least one additional condition, wherein the selected resource elements may be indicated in the configuration information for the user equipment as the resource elements to be muted.

The at least one additional condition may be that muting resource elements used for transmitting certain channels and/or certain signals should be avoided. For example, the rules I and/or II could be applied for this case.

The at least one additional condition may be that the number of resource elements to be muted fulfills a specific condition. For example, the rule III described above could be applied for this case.

The at least one additional condition may be that only resource elements in flexible uplink subframes are to be muted.

It is to be understood that any of the above modifications can be applied singly or in combination to the respective aspects and/or embodiments to which they refer, unless they are explicitly stated as excluding alternatives.

It is also noted herein that while the above describes example embodiments of the invention, these descriptions should not be viewed in a limiting sense, Rather, there are several variations and modifications which may be made without departing from the scope of the present invention as defined in the appended claims.

### LIST OF ACRONYMS, ABBREVIATIONS AND DEFINITIONS

CCE Control Channel Element
CRC Cyclic Redundancy Check
CRS Common Reference Signal (channel)
DL Downlink
DFT Discrete Fourier Transform
DRS Dedicated Reference Signal
eNB Enhanced Node B. Name for Node B in LTE
HARQ Hybrid Automatic Repeat request
HetNet Heterogeneous Network
LA Local Area
LTE Long Term Evolution
LTE-A Long Term Evolution Advanced
OFDM Orthogonal Frequency Division Multiplex
PCFICH Physical Control Format Indicator Channel
PDCCH Physical Downlink Control Channel
PDSCH Physical Downlink Shared Channel
PHICH Physical Hybrid ARQ Indicator Channel
PRB Physical Resource Block
PUSCH Physical Uplink Shared Channel
RE Resource Element
RRC Radio Resource Control
SC-OFDM Single Carrier Orthogonal Frequency Division Multiplex
TDD Time Division Duplex
UE User Equipment
UL Uplink

What is claimed is:

1. An apparatus, comprising
a transceiver module configured for time division duplex operation in a network environment,
a processor module and a memory storing computer instructions, which, when the stored computer instructions are executed by the processor module, cause the apparatus to:
determine resource elements in an uplink transmission of a user equipment on which interference may be caused and which are to be muted in the uplink transmission, and
prepare configuration information for the user equipment in which resource elements to be muted are indicated,
wherein the transceiver module is configured to send the configuration information to the user equipment.

2. The apparatus according to claim 1, wherein
the transceiver module is configured to obtain information from a neighboring cell, and
the processor module is configured to perform the determination of the resource elements to be muted based on the obtained information.

3. The apparatus according to claim 2, wherein the obtained information comprises at least one of the following:
information as to which signals and/or channels are reserved and/or need to be protected,
configuration of the reserved signals and/or channels to be protected,
physical layer cell identity of the neighboring cell,
interference level detected, and/or
time division duplex configuration of the neighboring cell.

4. The apparatus according to claim 2, wherein the processor module is configured to, in case information is obtained from more than one neighboring cell, select the resource elements to be muted based on information of one neighboring cell.

5. The apparatus according to claim 4, wherein the processor module is configured to select the one neighboring cell based on information regarding the strongest interference level.

6. The apparatus according to claim 1,
wherein the processor module is configured to select resource elements to be muted based on the resource elements determined as resource elements on which interference may be caused and based on at least one additional condition, and to indicate in the configuration information for the user equipment the selected resource elements as the resource elements to be muted.

7. The apparatus according to claim 6,
wherein the at least one additional condition is that muting resource elements used for transmitting certain channels and/or certain signals should be avoided.

8. The apparatus according to claim 6,
wherein the at least one additional condition is that the number of resource elements to be muted fulfills a specific condition.

9. The apparatus according to claim 6, wherein the at least one additional condition is that only resource elements in flexible uplink subframes are to be muted.

10. An apparatus, comprising
a transceiver module configured for time division duplex operation in a network environment and to receive configuration information indicating resource elements to be muted in an uplink transmission of the apparatus, and
a processor module and a memory storing computer instructions, which, when the stored computer instructions are executed by the processor module, cause the apparatus to: mute resource elements based on the received configuration information.

11. The apparatus according to claim 10,
wherein the processor module is configured to select the resource elements to be muted based on the received configuration information and based on at least one additional condition.

12. The apparatus according to claim 11,
wherein the at least one additional condition is that muting resource elements used for transmitting certain channels and/or certain signals should be avoided.

13. The apparatus according to claim 11,
wherein the at least one additional condition is that the number of resource elements to be muted fulfills a specific condition.

14. The apparatus according to claim 10, wherein the at least one additional condition is that only resource elements in flexible uplink subframes are to be muted.

15. A method, comprising, in a transceiving configuration for time division duplex operation in a network environment:
determining resource elements in an uplink transmission of a user equipment on which interference may be caused and which are to be muted in the uplink transmission,
preparing configuration information for the user equipment in which resource elements to be muted are indicated, and
sending the configuration information to the user equipment.

16. The method according to claim 15, further comprising
obtaining information from a neighboring cell, and
performing the determination of the resource elements to be muted based on the obtained information.

17. The method according to claim 16, wherein the obtained information comprises at least one of the following:
information as to which signals and/or channels are reserved and/or need to be protected,
configuration of the reserved signals and/or channels to be protected,
physical layer cell identity of the neighboring cell,
interference level detected, and/or
time division duplex configuration of the neighboring cell.

18. (canceled)

19. The method according to claim 18, wherein the one neighboring cell is selected based on information regarding the strongest interference level.

20. The method according to claim 15, further comprising
selecting resource elements to be muted based on the resource elements determined as resource elements on which interference may be caused and based on at least one additional condition, and
indicating in the configuration information for the user equipment the selected resource elements as the resource elements to be muted.

21-23. (canceled)

24. A method comprising, in a transceiving configuration for time division duplex operation in a network environment:
receiving configuration information indicating resource elements to be muted in an uplink transmission of a user equipment, and
muting resource elements based on the received configuration information.

25-27. (canceled)

28. The method according to claim 24, wherein the at least one additional condition is that only resource elements in flexible uplink subframes are to be muted.

29-30. (canceled)
